(19) United States
(12) Patent Application Publication
(10) Pub. No.: US 2012/0012007 A1
(43) Pub. Date: Jan. 19, 2012

(54) TRANSPORTABLE COMPACT MACHINE FOR PREPARING A DRINK

(75) Inventors: Christian Talon, Vufflens-le-Chateau (CH); Jean-Luc Denisart, Cully (CH); HansPeter Pleisch, Corseaux (CH); Alain Meier, Caneggio (CH)

(73) Assignee: NESTEC S.A., Vevey (CH)

(21) Appl. No.: 13/143,986

(22) PCT Filed: Jan. 11, 2010
(86) PCT No.: PCT/EP2010/050178

§ 371 Date: Jul. 11, 2011

(30) Foreign Application Priority Data
Jan. 13, 2009 (EP) 09150461.3

(51) Int. Cl. B67D 1/00

(52) U.S. Cl. 99/275

(57) ABSTRACT

Machine for preparing a drink, which comprises a body (20) and a head (21) fitted with a liquid-injection assembly (6), which comprises a support (7) to accommodate a portion of food ingredients and comprising a passage (10) through which the said drink can flow, the said head (21) being mounted on the said body (20) such that it can move in order to move from a retracted stowage position, in which the space occupied by the machine is minimal and the passage (10) is covered, into a deployed service position in which the space occupied by the machine is greater than the space occupied in the retracted position. In the retracted position, a housing (33) is provided in the head to accommodate the support (7) and, in the deployed position, the passage (10) is uncovered in order to allow the drink to flow over an empty space intended for the insertion of a container.

The present invention relates to a machine for preparing a drink. It relates more particularly to a machine of the type comprising an injection assembly, designed to accommodate a portion of ingredients, such as a ground mass, a soluble powder, or a liquid concentrate, into which a liquid, preferably water, is injected to extract, infuse or dissolve the ingredients.

Such machines are, for example, coffee machines of the espresso type, using disposable packages of ground mass of the type described in patent EP1688072. These machines generally occupy a great deal of space because of the arrangement of the injection assembly which has to be situated over an empty space into which a cup will be inserted. For this reason, most of the machines on the market are designed for use as a fixed installation rather than to be transportable.

Now, it may be advantageous to have a compact and stand-alone travelling machine intended to be carried about. A compact machine is disclosed in document U.S. Pat. No. 4,760,774, which sets out a coffee machine formed of a body and of a head mounted on the body such that it can pivot between a retracted position occupying a minimum amount of space and a deployed service position. The head comprises an injection unit for injecting water into a coffee container. In the retracted position, the injection unit is inaccessible because it is covered by the body of the machine and the support for containing the coffee is kept separate from the head. The pivoting of the head has the effect of swinging the said passage over an empty space, available for inserting a cup. This feature makes if possible to reduce the space occupied by the machine in the retracted position, the volume normally left for inserting the cup not forming an integral part of the machine in this configuration. However, the head described in document U.S. Pat. No. 4,760,774 is not entirely functional once deployed. The coffee support has to be assembled and locked onto the injection unit mounted in the said head. This operation is inconvenient, and the manipulations involved may be performed incorrectly. In addition, it assumes that a coffee support has to be carried around separately from the machine. The advantage afforded by the compactness of the machine is thereby lessened, and there is a risk that the coffee support may be misplaced.

The object of the present invention is to remedy these drawbacks, by providing a machine for preparing a drink which is compact, stand-alone and simple to use. More specifically, the invention relates to a machine for preparing a drink, which comprises a body and a head fitted with a liquid-injection assembly, which comprises a support to accommodate a portion of food ingredients comprising a passage through which the said drink can flow, the head being mounted on the said body such that it can move in order to move from a retracted stowage position, in which the space occupied by the machine is minimal and the passage is covered, into a deployed service position in which the space occupied by the machine is greater than the space occupied in the retracted position and the passage is uncovered in order to allow the drink to flow over an empty space intended for the insertion of a cup. In addition, according to one feature of the invention, in the retracted position, a housing is provided in the head to accommodate the support. In that way, the support may be housed in the head when the head is in the retracted position, thus affording a design that is more compact and making it easier to be carried around in a single piece without any separate parts.

According to one feature of the invention, the injection assembly comprises a removable support to accommodate a portion of food ingredients, the support being ready to be inserted into or removed from the head when the head is in the retracted position.

By virtue of this feature, the support for accommodating the food portion is mounted on the machine when the head is in the retracted position. The support may be stowed or transported with the machine, thus limiting the risks of losing it and making the machine more compact.

According to a preferred embodiment, the housing designed to accommodate the support is the one in which the support is in position at the time of the injection of the liquid and the flow of the drink. In another possible embodiment, the housing may also be a stowage housing separate from the housing that positions the support for injecting the liquid and for the flow of the drink.

According to one aspect of the invention, said liquid-injection assembly comprises means of locking the said support. The locking means are associated with means of injecting the liquid into the food portion contained in the support. The locking means are arranged set back from the support when the head is in the retracted position so that the support is free to be inserted into the housing in the head. Thus, the support can be placed in the stowage position or may be loaded with a portion of food ingredients before the locking means are actuated to lock the said support.

In one advantageous embodiment, the liquid-injection assembly comprises means of locking the support, which means are equipped with a control designed to actuate them automatically when the head of the machine moves from the retracted position to the deployed position.

In particular, the control comprises a lever acting on a rotational-locking mechanism of the cam type, the said lever rotating the locking mechanism as a result of the movement of the head between its retracted position and its deployed position.

By virtue of this feature, the machine is directly operational once the head has been deployed, this considerably simplifying its use and reducing the risks of incorrect manipulation.

The means of locking the support preferably comprise a clamping mechanism of the cams type comprising a compression surface which applies a compression force against the food portion and/or the support containing the said portion. The compression surface is preferably in the form of a disc. It may be convex in order by compression to deform a flexible surface of a capsule containing the ingredients and thus at least partially expel the gases contained in the said capsule in order to reduce the risk of resurgence upon re-opening.

A sealing means may be provided which can be compressed against the surface of the portion, for example a capsule, contained in the support, this means being such as a layer of elastomeric material covering all or just part of the surface. The sealing means could also seal only around the periphery of the support rather than over the surface of the portion (capsule), for example by means of an elastomer O-ring forming part of the compression surface and/or of the support.

The injection means comprise at least one needle for injecting the liquid that forms a jet of pressurized liquid.

In the context of the invention, the term “drink” extends to any type of liquid food preparation including a culinary preparation such as a soup, sauce, baby milk, etc.

Other characterizing features and advantages of the present invention will more clearly emerge from the following detailed description of an example of the construction of a machine for preparing a drink according to the invention, this example being given only for purely illustrative and non-limiting purposes, in conjunction with the appended drawing in which:

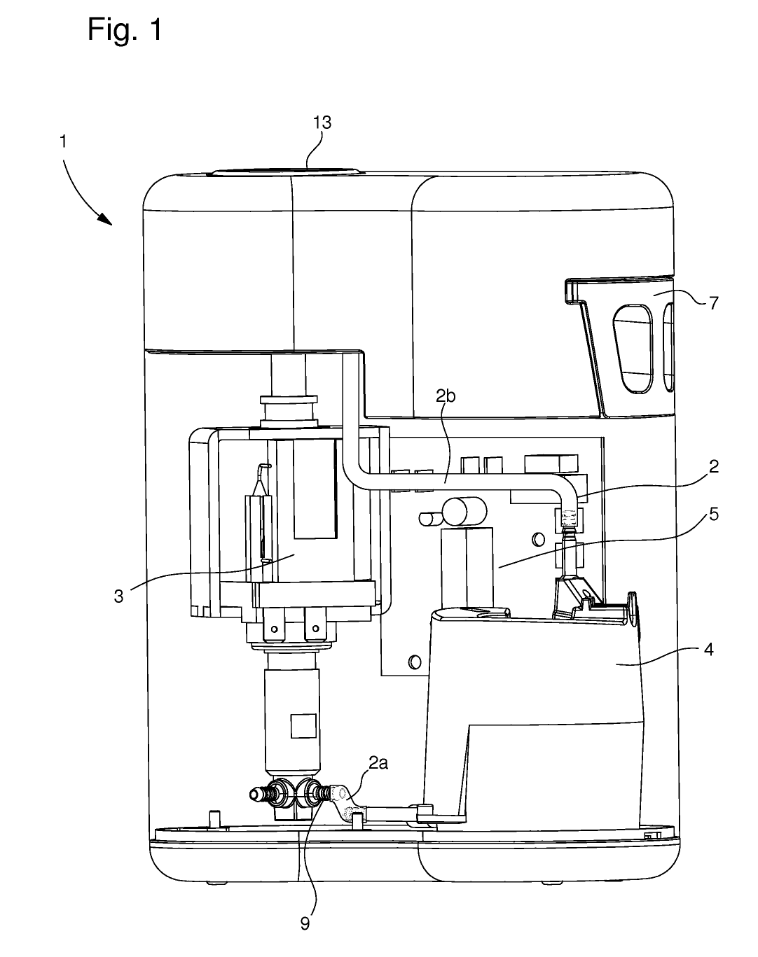

FIG. 1 is a view, slightly in perspective and in partial cross-section of a first embodiment of a machine for preparing a drink according to the invention;

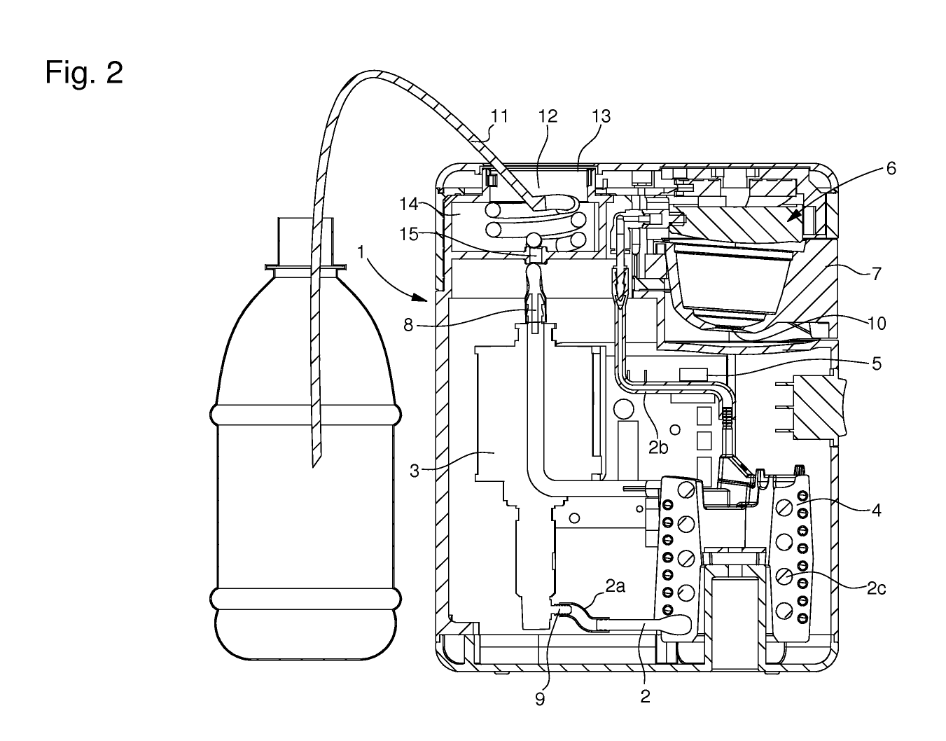

FIG. 2 is a longitudinal sectional view of the machine of FIG. 1;

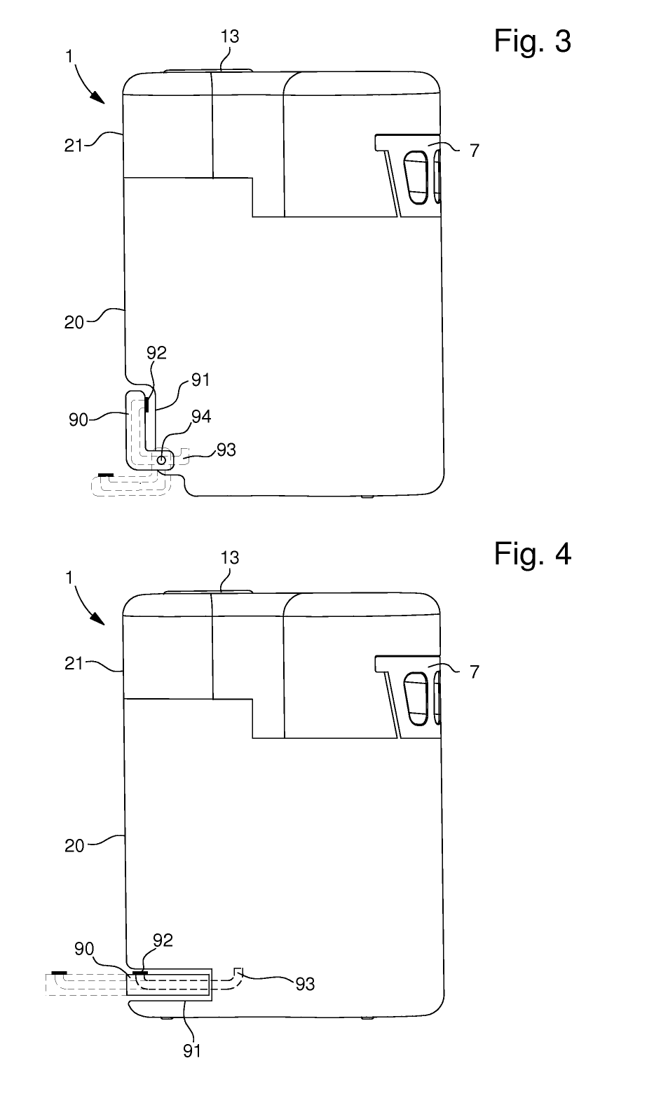

FIGS. 3 and 4 are side views of a second embodiment of a machine for preparing a drink according to the invention;

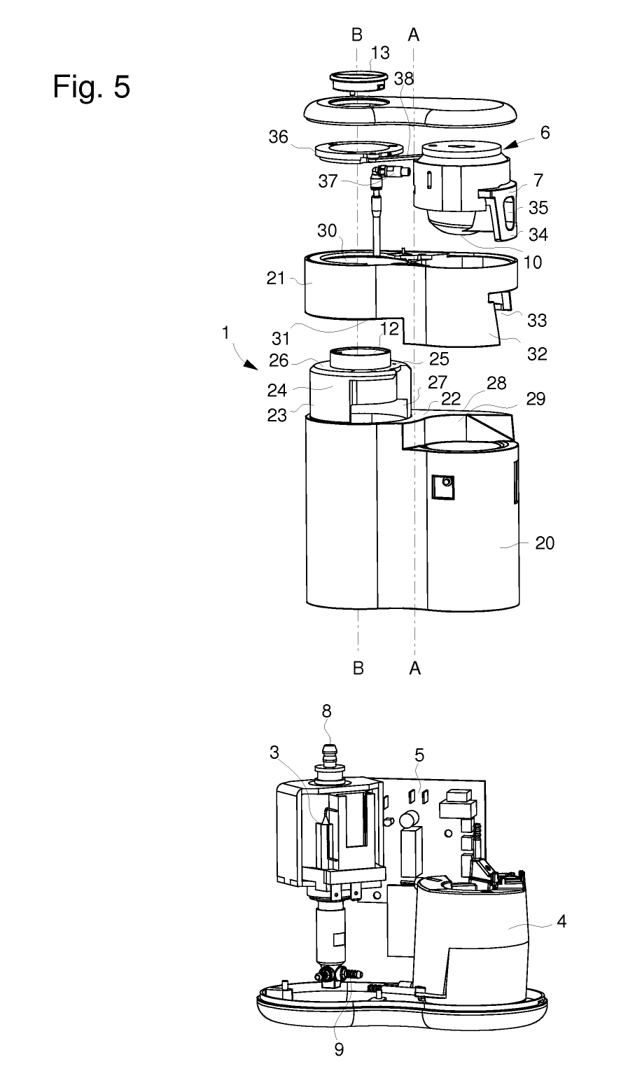

FIG. 5 shows an exploded view of the machine according to the first embodiment of the invention;

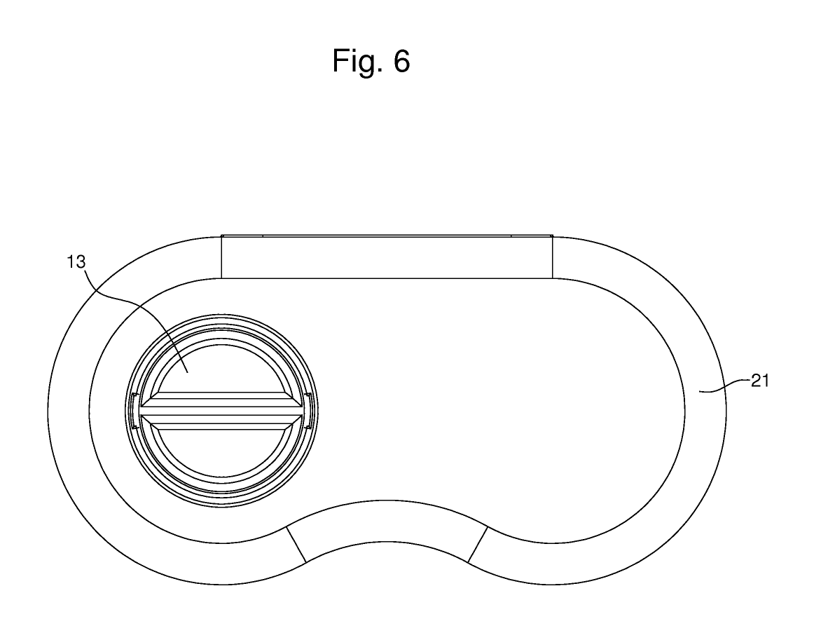

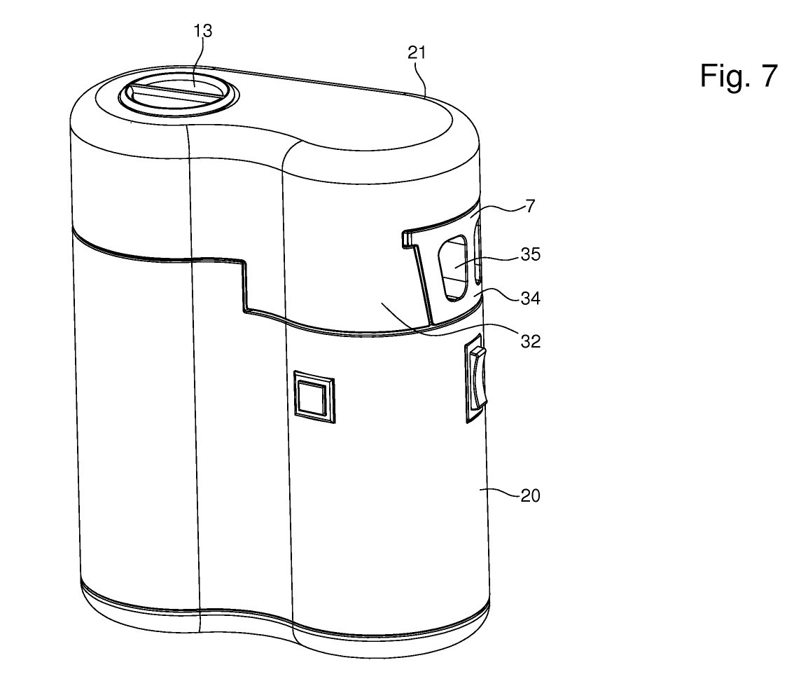

FIGS. 6 and 7 illustrate the machine in the retracted position, as a top view and a perspective view respectively;

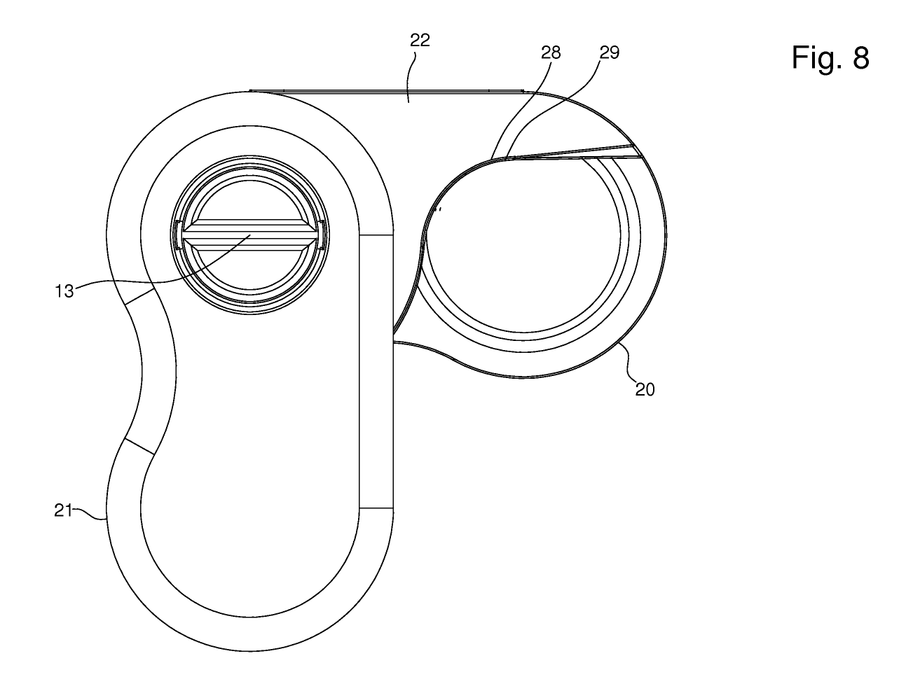

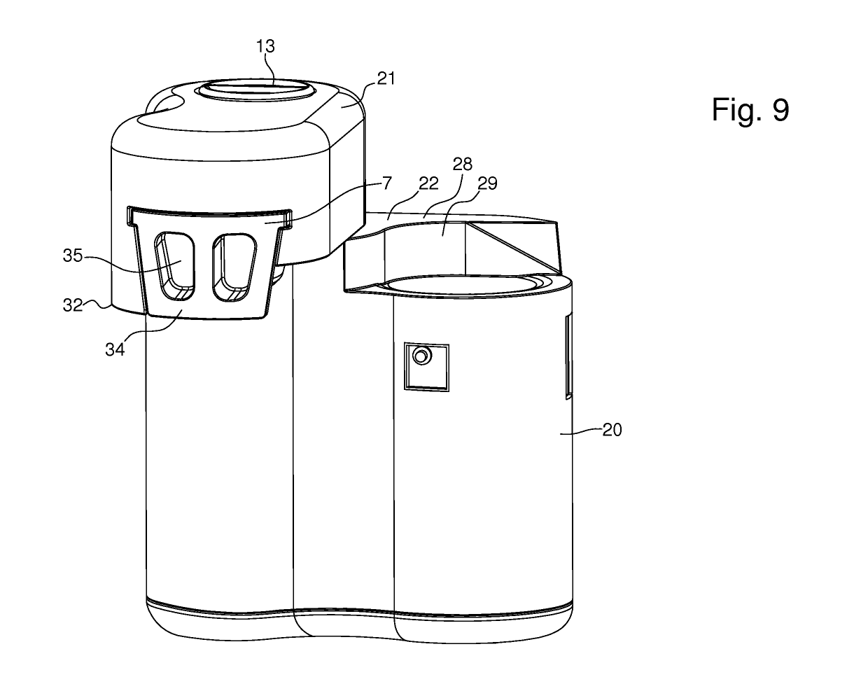

FIGS. 8 and 9 illustrate the machine in the deployed position, as a top view and a perspective view respectively;

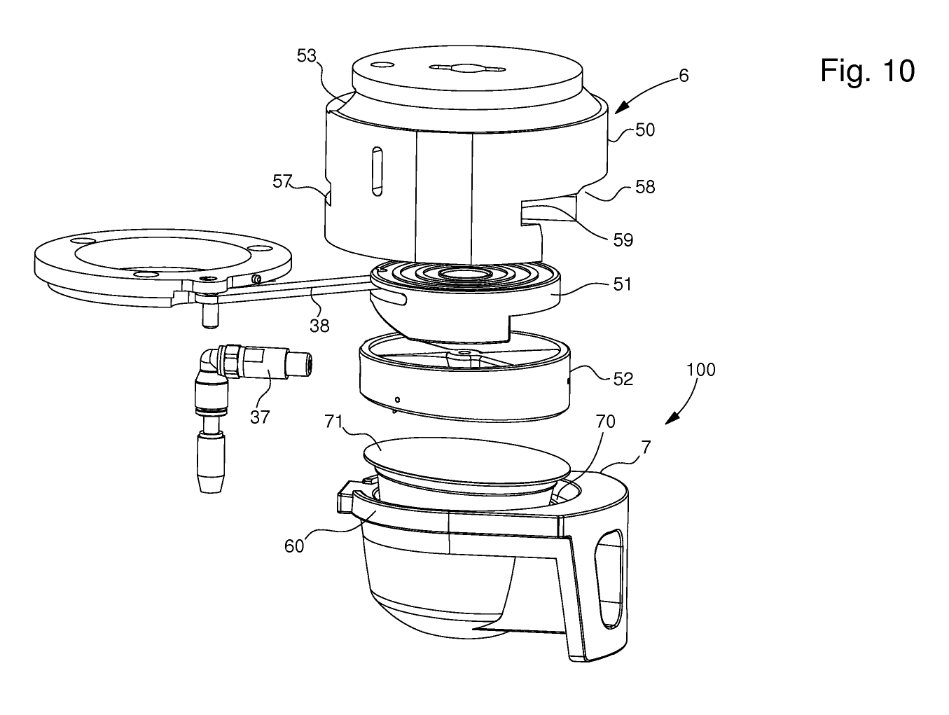

FIGS. 10 to 12 show a first embodiment of the injection unit, in an exploded view, in cross section in the up position and in cross section in the down position, respectively;

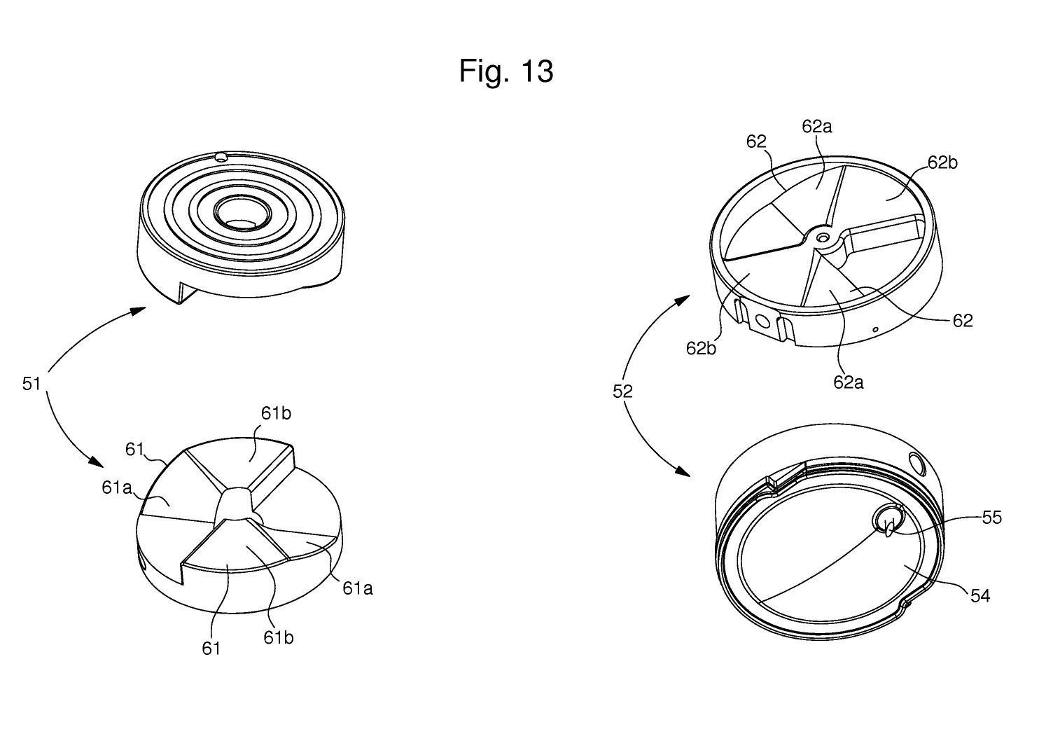

FIG. 13 shows a perspective view of two of the elements of this first embodiment of the injection assembly;

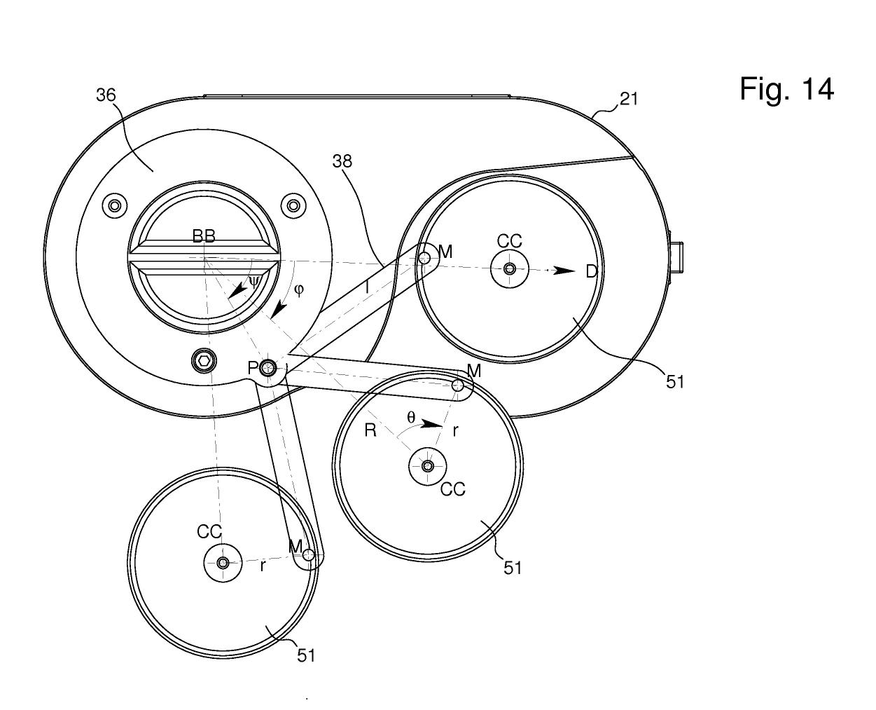

FIG. 14 is a top view of said first embodiment of the injection assembly and of its control;

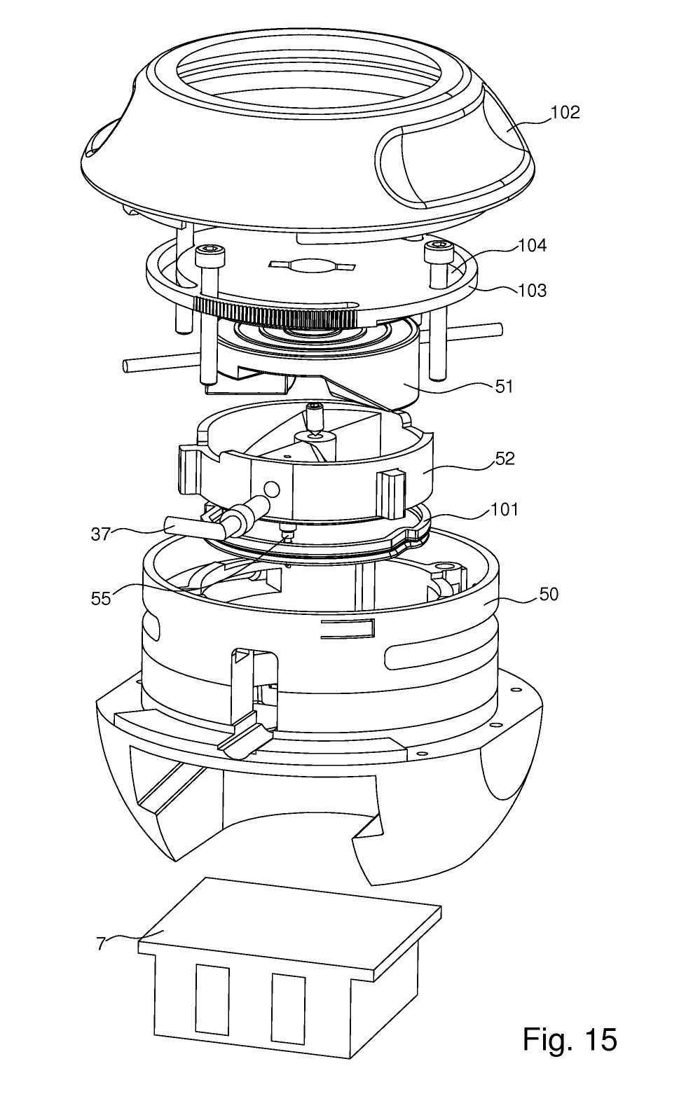

FIG. 15 shows an exploded view of a second embodiment of the injection assembly;

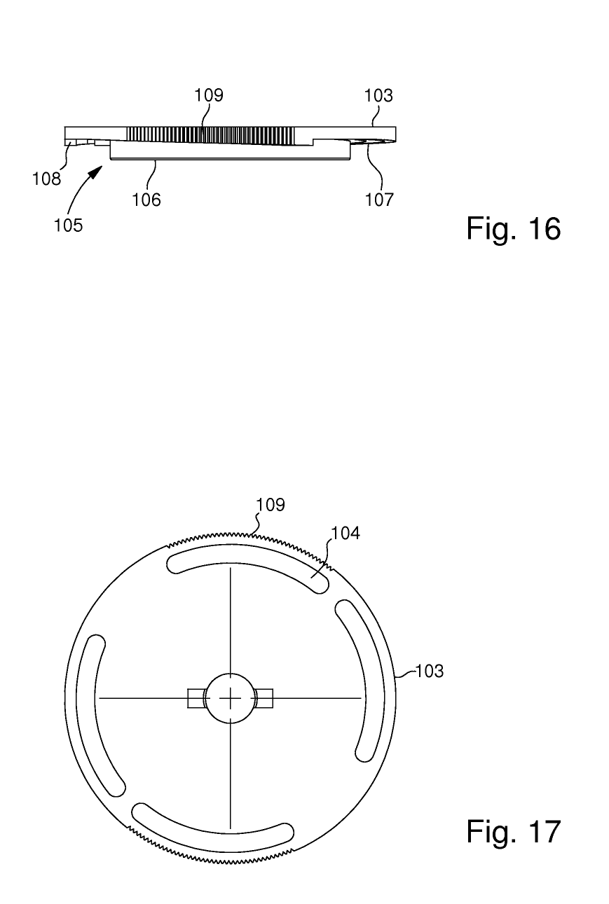

FIGS. 16 and 17 are side and top views, respectively, of a first element of this second embodiment of the injection assembly;

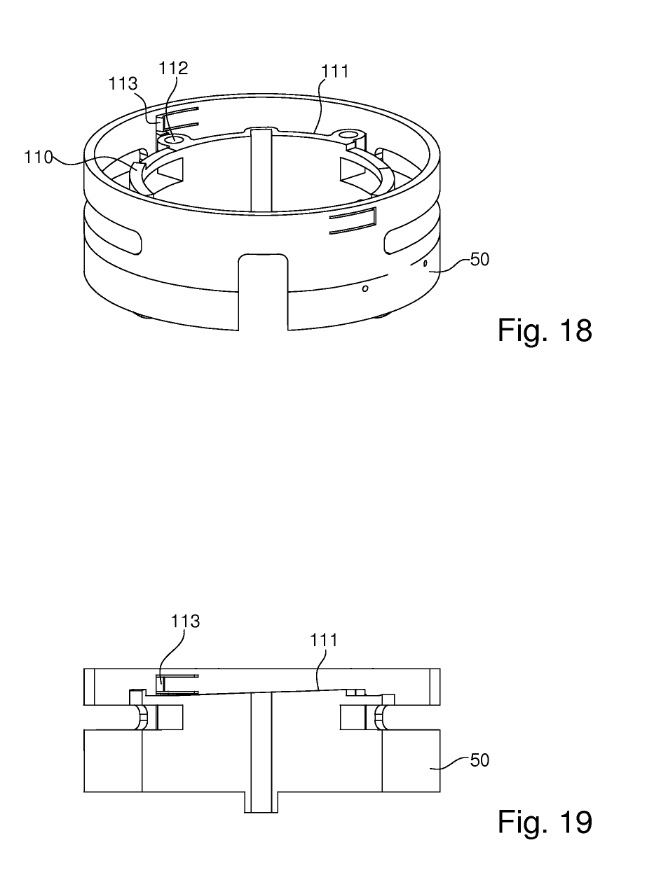

FIGS. 18 and 19 are views, in perspective and in axial section respectively, of a second element of this second embodiment of the injection assembly; and

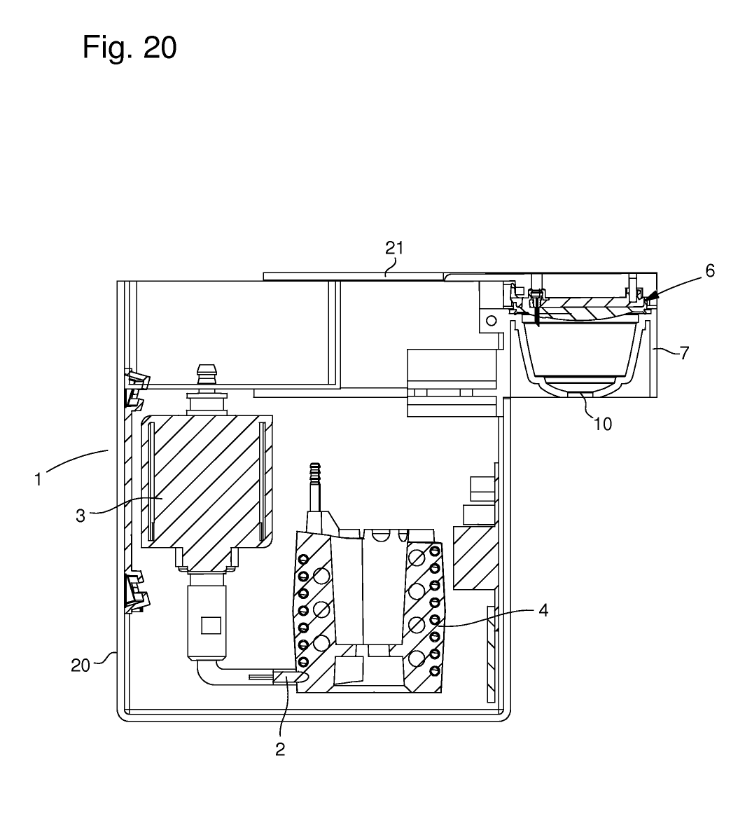

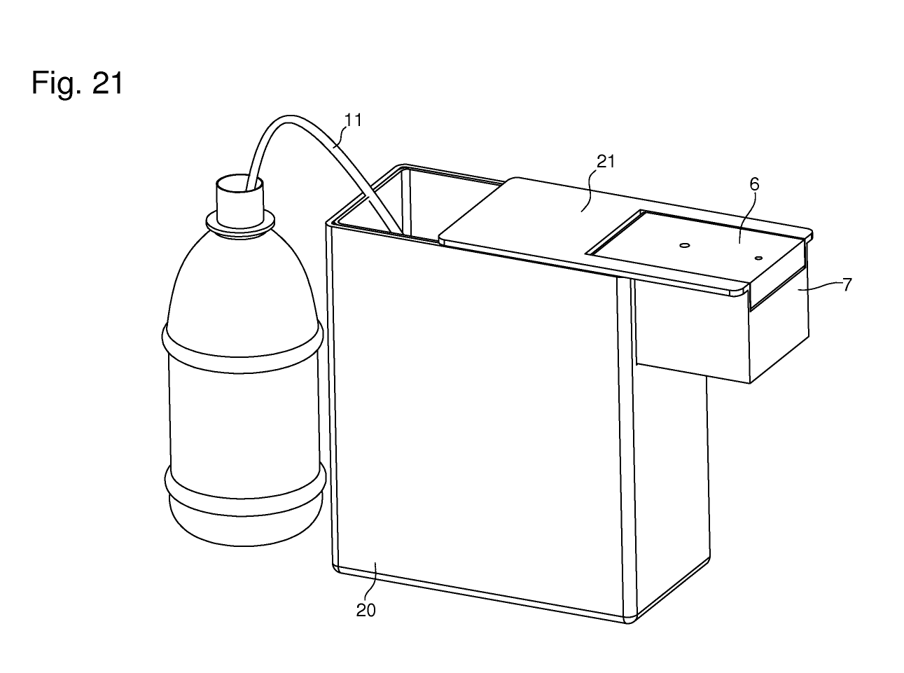

FIGS. 20 and 21 illustrate a third embodiment of a machine according to the invention, as a sectional view and a perspective view respectively.

The machine for preparing a drink, shown in perspective and in longitudinal section in FIGS. 1 and 2 respectively, conventionally comprises a casing 1 defining an internal volume in which are housed a hose 2, intended for the circulation of a liquid, typically water, for preparing the drink, a pump 3 intended for delivering the liquid into the hose 2, a liquid heater 4, for example a block heater, in order to bring the liquid to the desired temperature, electronic control means 5, for controlling the pump 3 and the block heater 4, and an injection assembly 6, in which the liquid is injected into an injection chamber containing the ingredients for the purpose of extracting therefrom a substance for the preparation of the drink. Said substance is extracted, in the injection assembly 6 either by extraction, for example for preparing a coffee from a ground mass, or by infusion, for example for preparing tea or tisane from leaf fragments, or by dissolution, for example for preparing a drink based on coffee, milk and/or chocolate using soluble powers. In the embodiment shown, the injection assembly 6 has a support 7 designed to accommodate a removable capsule and mounted so as to slide in the manner of a drawer. This capsule support 7 may be configured to accommodate a capsule of the type described in documents EP 1 472 156 and EP 1 688 072. As a variant, the support 7 may be configured to accommodate a filter sachet or any other type of flexible or rigid package. It may also be designed for directly accommodating an unpackaged portion of a ground mass, soluble substance or liquid concentrate.

In the embodiment illustrated, the hose 2 has a rigid central portion 2c formed from a metal pipe, for example made of copper, integrated into the block heater, and two flexible portions 2a and 2b on either side of the rigid portion 2c of the block heater, for example formed from silicone pipes. The pipe portions are connected via rigid couplers, mounted for example on the block heater. Of course, other in-line heating means may be provided as an alternative, such as a cartridge heater or a tube heater. The pump 3 has an intake coupler 8 and a delivery coupler 9 to which the hose portion 2a is connected. The hose portion 2b is connected to the injection assembly 6, while the central portion 2c passes through the block heater 4 for raising the temperature of the liquid. The injection assembly 6 includes, by means of the capsule support 7, a passage 10 through which the prepared drink can flow.

According to one possible aspect of the invention, the machine for preparing a drink does not include a liquid reservoir, rather liquid intake means, for bringing liquid from outside the casing (from an external source) into the latter, which means can be at least partially deployed to the outside of the casing. The liquid intake means are formed, in a first embodiment illustrated in FIG. 2, by a flexible intake hose 11, housed in the internal volume of the casing 1 and connected via a first end to the intake coupler 8 of the pump 3. The hose 11 can be deployed from inside the casing 1 to the outside through an orifice 12 made in the casing 1, so that a second end is dipped into a liquid contained in a reservoir external to the machine. Said reservoir may be a flask, bottle or any other container provided with an opening. The orifice 12 is closed off by a removable cover 13.

The arrangement according to one possible aspect thus described makes it possible to reduce the internal volume of the casing 1, because of the absence of a liquid reservoir and a reservoir support permanently placed in and associated with the casing. The machine for preparing a drink according to the invention thus is more compact and is lighter than a machine according to the prior art. Thanks to these characterizing features and to the deployable hose 11 housed in the casing 1, the machine according to the invention can be easily transported and is easy to stow. Its operation is similar to the operation of a conventional machine, except that the liquid is taken in by the pump 3 from an external reservoir independent of the machine using the deployable hose 11.

In one possible alternative embodiment, the machine according to the invention could also include a small reservoir (having a maximum capacity of 250 ml), which may or may not be removable.

In the embodiment shown in FIG. 2, the casing 1 includes a compartment 14, located close to the pump 3, for example above it, in which the flexible intake hose 11 is housed. The compartment 14 is provided with an internal opening 15 for the passage and connection of the intake hose 11 passes, to the pump 3. In a variant (not shown), the flexible intake hose 11 is entirely housed in a compartment not located close to the pump 3. It is completely extracted from said compartment and then connected temporarily to the pump 3, via a first end, for the time needed to prepare a drink. In one or other variant, the hose 11 is integrated into the casing, thereby creating a compact stand-alone machine.

In a second embodiment of the machine, illustrated in FIGS. 3 and 4, the liquid intake means, for bringing liquid from outside the casing 1 into the latter, are formed by an intake hose that includes a rigid portion 90. The rigid portion 90 is mounted so as to be articulated on or slide in a housing 91 external to the casing 1, between a retracted position and a protruding position. For this purpose, the casing 1 includes an external housing 91 designed to accommodate said rigid portion 90 in the retracted position. The rigid portion 90 is provided with a connector 92 for connecting a removable liquid reservoir. The intake hose further includes a second, rigid or flexible, portion 93 housed inside the casing 1 and connected via a first end to the rigid portion 90 and via a second end to the pump 3. As previously, the machine thus described is compact and stand-alone.

In the embodiment shown in FIG. 3, the rigid portion is articulated so as to rotate on the base of the body 20 about a rotation axis 94 between a retracted position, in which it is in an open housing 91, and a deployed position, in which the portion extends horizontally and the connector 92 is turned upwards so as to receive a removable reservoir (not shown).

In the embodiment shown in FIG. 4, the support is mounted so as to slide in the housing 91. It can therefore move horizontally from a retracted position to a deployed position.

The construction of the machine according to the invention will be described in greater detail with regard to FIG. 5, and with reference to the central longitudinal axis A-A of the casing 1.

The casing 1 is formed by a body 20, in which the pump 3 provided with the couplers 8 and 9, the hose 2, the block heater 4 and the electronic control means 5 are mounted, and by a head 21 in which the injection assembly 6 provided with the passage 10 is mounted. The body 20 and the head 21 are for example made of an injection-moulded or thermoformed plastic or made of a metal such as aluminium.

The head 21 is mounted so as to pivot on the body 20 about a longitudinal axis B-B transversely offset relative to the axis A-A, between a retracted, stowed position and a deployed, service position. For this purpose, the body 20 has an upper face 22 surmounted by a male cylindrical portion 23 of axis B-B, the external face 24 of which forms a guide surface for the head 21. The cylindrical portion 23 is provided with a shoulder 25 forming a support surface 26 for the head 21. It also includes a cut-away 27 intended for the hose 2 to pass through to the injection assembly 6. The upper face 22 also has a projection 28 forming an abutment surface 29 that defines the limit of said retracted position.

The head 21 has a female cylindrical portion 30 of axis B-B, matched to the diameter and height of the male cylindrical portion 23 of the body. It also includes a lower face 31 provided with a projecting portion 32, matched to the shape and size of the projection 28 and intended to come into contact with the abutment 29 when the head is in the retracted position. The head 21 also includes a housing 33 into which is inserted the removable capsule support 7 forming part of the injection assembly 6. The capsule support 7 has, for this purpose, lateral guiding means for being inserted into the housing 33 and an outer face 34 matched to the shape and dimensions of the housing 33 so as to be inserted into the head 21. The outer face 34 is provided with two openings 35 intended for taking hold of the capsule support 7.

The female cylindrical portion 30 is mounted so as to rotate freely on the male cylindrical portion 23 and prevent said female cylindrical portion from moving translationally by a ring 36 fixed to the support surface 26. The head 21 is thus free to pivot on the body 20. The hose 2 passes from the body 20 to the head 21 via the cut-away 27. It is connected via its second end to a coupler 37 which is itself mounted on the injection assembly 6. The hose portion 2b is advantageously flexible, so as to follow the movement of the head 21 when the latter pivots on the body 20. In a first embodiment of the injection assembly 6, a lever 38 is mounted so as to be articulated via a first end on the ring 36 and via a second end on the injection assembly 6 that it controls. The construction and the operation of this first embodiment of the injection assembly 6 and of its control will be described in greater detail with regard to FIGS. 10 to 14. In a second embodiment of the injection assembly 6, the lever 38 does not exist. The construction and the operation of this second embodiment will be explained in detail with regard to FIGS. 15 to 19.

The machine in the retracted position is shown as a top view and as a perspective view in FIGS. 6 and 7 respectively. In this retracted position, the projecting portion 32 comes into contact with the abutment surface 29. The head 21 and the body 20 are aligned so as to form a compact block taking up a minimum amount of space. The capsule support 7 is inserted into the head 21. In the retracted position, the capsule support may be removed and then repositioned at any time in order to place or withdraw a capsule because of the distance from the actual injection means, as will be explained later. The passage 10 through which the drink is intended to flow is covered, since it is located directly above the body 20. A machine may thus be stowed in a small space, such as in a case so as to be easily transported. The machine may also be used in a small kitchen space and stowed more easily in a cupboard.

The machine in the deployed position is shown as a top view and a perspective view in FIGS. 8 and 9 respectively. The extent to which the head is deployed is determined by the construction of the injection assembly 6, which will be described in greater detail with regards to FIGS. 10 to 14. In the deployed position, the capsule support 7 is inserted into the head 21 and locked so as not to be able to be removed during preparation of the drink. The head 21 is partly disengaged from the body 20 so as to expose the passage 10 through which the drink is intended to flow. A container, such as a flask, may be placed in the free space located beneath the passage 10, for the purpose of collecting the drink.

Reference will now be made to FIGS. 10, 11 and 12 which show a first embodiment of the injection assembly 6 in an exploded view, in a sectional view in the up position and a sectional view in the down position, respectively. The injection assembly 6 is formed by a frame 50 in which a cam means is mounted. More precisely, mounted in the generally cylindrical frame 50 are, in succession, a rotatable cam 51, a cam follower 52 which can move in axial translation between an up position and a down position, and the sliding capsule holder 7. The cam follower 52 forms, with the capsule holder 7, the upper part and the lower part, respectively, of an injection chamber 100 in which the liquid comes into contact with a consumable product for making a drink. The injection chamber may be bounded by a capsule 71 containing the ingredients, not forming part of the device as such but being positioned between the upper part and the lower part.

The lever 38 is mounted articulatedly via a second end to the cam 51 through a first slot 53 extending angularly in the frame 50. The cam follower 52 has a lower face 54 covered for example with a layer of an elastic sealing material, such as for example rubber, intended to come into contact with the injection surface of the capsule. The cam follower is provided with a hollow needle 55, intended for piercing the capsule and for injecting liquid thereinto, and communicating with a radial blind hole 56. The coupler 37 is sealingly mounted in the blind hole 56 through a second slot 57 made longitudinally in the frame 50. Thanks to the radial blind hole 56 and the coupler 37, the arrival of liquid takes place radially relative to the cam follower 52, thereby enabling the cam 51 to be superposed. The cam follower 52 is kept in the up position by a return spring (not shown). Finally, the frame 50 has an axial housing 58 for inserting the capsule support 7, and an internal groove 59 open onto the housing 58. The capsule support 7 is provided with a rim 60 intended to slide in the groove 59 and with a circular shoulder 70 forming a bearing surface for a capsule 71.

The cam 51 and the cam follower 52 are shown in perspective in FIG. 13. They cooperate through two sets of inclined surfaces, referenced 61 and 62 respectively, designed so that the cam 51 makes the cam follower 52 move translationally when it is subjected to a rotational movement. This type of construction and movement is known to those skilled in the art. It should be noted that the surfaces 61 and 62 have highly inclined first portions, 61a and 62a respectively, and slightly inclined second portions, 61b and 62b respectively, which extend angularly from the first portions 61a, 62a.

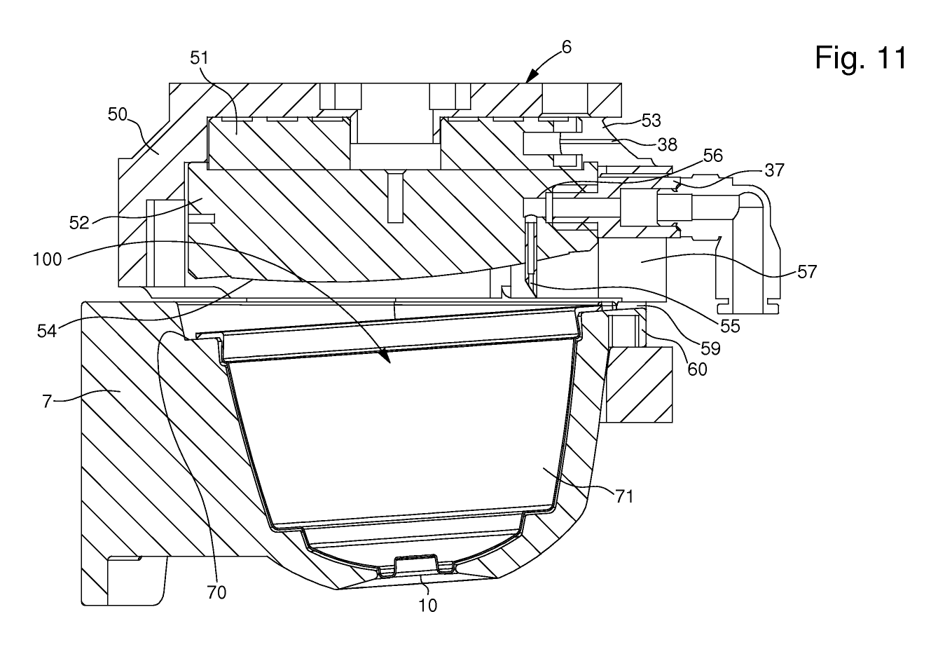

In the up position, as shown in FIG. 11, the relative orientation of the cam 51 and the cam follower 52 is chosen so that the surfaces 61a and 62a are in contact with each other, without cooperating. The return spring presses the cam follower 52 against the cam 51 leaving the cut-away 33 free for introducing or withdrawing the capsule holder 7. In the position thus described, the injection chamber 100 is open.

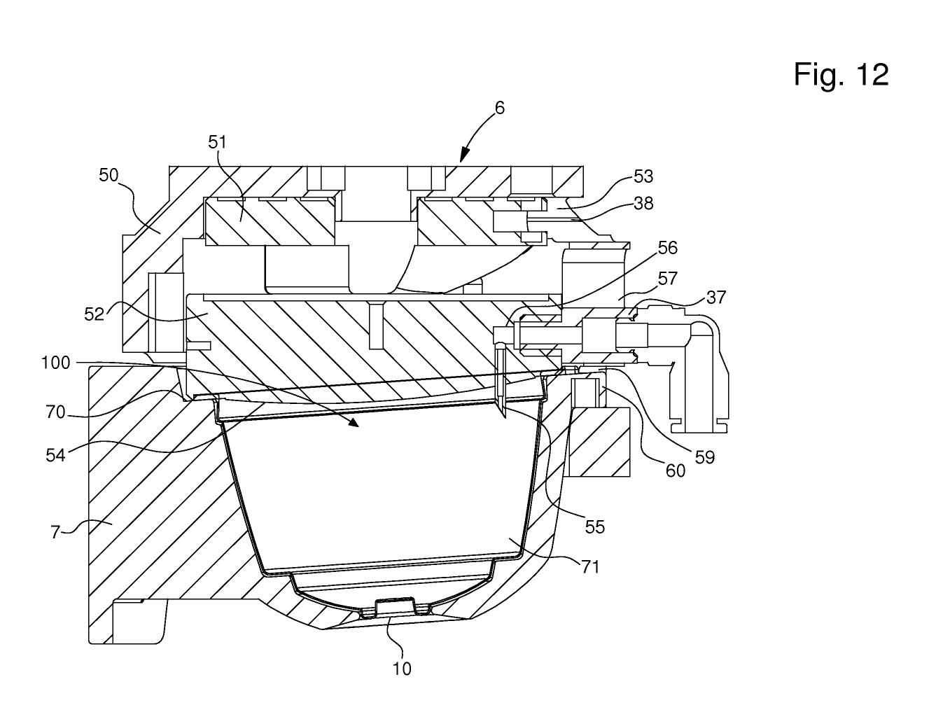

When the cam 51 rotates, the surfaces 61a and 62a cooperate and the cam follower 52 moves towards the capsule support 7. The geometries of the inclined surfaces 61 and 62 are chosen so that at the end of the first portions 61a, 62a, the cam follower 52 comes into contact, via its lower face 54, with the capsule 71 housed in the capsule support 7. At this point in the rotational travel of the cam 51, the cam follower 52 is in the down position, shown in FIG. 12, and the needle 55 pierces the foil seal of the capsule 71. In this position, the injection chamber 100 is closed, but not yet clamped.

The second surface portions 61b, 62b are intended for clamping the injection assembly 6. When the cam 51 and cam follower 52 have travelled beyond the first portions 61a, 62b, the second portions 61b, 62b cooperate so that the cam follower 52 presses firmly onto the capsule, which itself bears on the shoulder 70. The pressure exerted by the surface 54 being in contact with the upper surface of the capsule 71 makes the assembly of the cam follower 52 and the capsule 71 liquid-tight. Sealing is achieved by a rubber film covering the face 54. The clamping thus locks the capsule support 7 in the inserted position. In this position, the injection chamber 100 is closed and clamped. The liquid can be injected into the capsule 71 from the hose portion 2b, through the coupler 37 and then the needle 55. Alternatively, sealing could be achieved locally by a seal positioned on the periphery of the clamping surface 54 so as to cooperate with the rim of the capsule 71.

The operation of controlling the injection assembly 6 is shown in FIG. 14. The head 21 appears (partly) in this figure in the retracted position, in the deployed position, and in an intermediate position. The axis BB is the rotation axis of the head 21. The rotation axis of the cam 51 is CC and the line passing through the axes BB and CC is D. The point of articulation of the lever 38 on the fixed ring 36 is P and the point of articulation of the same lever 38 on the cam 51 is M. The line passing through the point P and the axis BB makes an angle ψ with the line D, and the length of the lever 38 is l.

In the retracted position, the point M is located on the line D, closest to the axis BB. When the head is deployed by rotating it, the length l of the lever 38 being fixed, the point M moves about the axis CC so as to maintain this length. The cam 51 is thus rotated. An equation exists between the rotation angle θ of the cam 51 and the deployment angle φ of the head 21. This equation is complex and depends on the initial geometric parameters of the system, namely the angle ψ and the length l. The discussion will be limited to mentioning the fact that when the deployment angle φ, of the head 21 increases, the rotation angle θ of the cam 51 increases up to a maximum value θₘₐₓ and then decreases. The value θₘₐₓ gives the maximum angular travel of the cam 51.

In practice, the injection assembly 6 is designed to be controlled so that the head 21 is deployed as far as an angle φ_{dep} corresponding to a rotation angle θ_{dep} of the cam 51 which is smaller than the angle θₘₐₓ. This is because it is undesirable for θ_{dep} to equal or approach the angle θₘₐₓ when opening the machine to prepare a drink, since beyond this angle the cam follower 52 rises again, and the clamping of the injection chamber 100 lessens. The initial parameters, namely the angle ψ and the length l, are chosen so as to have a large deployment angle of the head 21 and a large rotation angle θ_{dep} of the cam 51. This is because the head 21 must be greatly extended in order for the passage 10 to be well exposed and for a flask to be placed thereunder for the purpose of collecting the drink. In addition, if the rotation angle θ_{dep} of the cam 51 is small, the surfaces 61a and 62a must be steeply inclined in order to make the cam follower 52 perform its entire travel, from the up position to the down position. In this case, the forces that are exerted on the parts are considerable, a high stress is required to open the head 21, and the surfaces 61, 62 are rapidly worn. It is therefore desirable to have a large rotation angle θ_{dep} of the cam 51.

It should also be noted that the clamping force applied by the cam 51 and cam follower 52 on the injection chamber 100 must be precisely controlled. This is because the chamber must be kept sealed during injection of the liquid with a certain pressure, otherwise there will be leaks and a risk of injuring the user. To achieve this, the clamping force must be sufficient. However, certain parts, such as the capsule holder 7, may be made of plastic, and so they may be damaged by an excessively high clamping force. The clamping of the injection chamber 100 must preferably be carefully calibrated.

However, the combined play due to the tolerances on the various parts of the injection assembly 6 may result in clamping values that deviate from the permitted limit values. The clamping of the injection chamber 100 depends directly on the translational travel of the cam follower 52, which itself depends on the rotation angle θ_{dep} of the cam 51. To compensate for the manufacturing and mounting play of the various parts, and thus optimize the clamping value of the injection chamber 100, the length l of the lever 38 is acted on slightly, thereby having an effect on the rotation angle θ_{dep} of the cam 51. To do this, the lever 38 is pierced with an oblong hole via which it is fixed to the ring 36. Thanks to this movement, the useful length of the lever 38 may be adjusted.

The method of automatically controlling the injection assembly 6 thus presented is advantageous for two reasons. Firstly, it should be noted that the control formed by the lever 38 fixed to the ring 36 is extremely simple and compact. No part is deployed, even partially, to the outside of the casing 1, making it easier to stow and transport the machine. Secondly, the injection assembly 6 is controlled automatically since it actuated by deploying the head 21. The handling of the machine according to the invention is simplified since it is operational in a single movement. Furthermore, it is impossible to start the machine without having locked the capsule support 7, thereby reducing the risk of it being incorrectly manipulated.

A second embodiment of the injection assembly 6 is illustrated in FIGS. 15 to 19. This second embodiment differs, in its principle, from the previous one in that the closure control is not linked to the deployment of the head. FIG. 15 is an exploded view of this manual injection assembly 6. As described previously, it comprises a generally cylindrical frame 50 in which are mounted, in succession, a cam 51 which can rotate, a cam follower 52 which can move in axial translation between an up position and a down position, and the sliding capsule holder 7. In the configuration shown, the injection assembly 6 also includes an intermediate piece 101, inserted between the cam follower 52 and the capsule holder 7. The intermediate piece 101 is fastened to the cam follower 52, by clip-fastening, clamping or adhesive bonding. It is covered, on its lower face, with a layer of an elastic sealing material and is sealingly penetrated by the hollow needle 55. It forms, with the capsule holder 7, the upper part and the lower part of the injection chamber 100, respectively. As a variant, the intermediate piece 101 is independent of the cam follower 52. In this case, it is mounted so as to move translationally inside the frame 50 and is itself provided with a hollow needle 55 intended for piercing the capsule and for injecting liquid thereinto, said needle communicating with a radial blind hole 56 provided for the arrival of the liquid. In a second variant of this configuration, the cam follower 52 merges with the intermediate piece 101 and itself forms the upper part of the injection chamber 100, as described with regard to FIG. 10.

The second embodiment of the injection assembly 6 also includes, at the top of the frame 50, a rotary control knob 102 mounted so as to rotate as one with the cam 51. An adjustment piece 103, visible in FIGS. 16 and 17, is inserted between the control knob 102 and the cam 51. This piece 103 forms overall a disk provided with four oblong openings 104 angularly distributed on the periphery thereof. Its lower face 105 comprises a flat central portion 106, intended to cooperate with the upper face of the cam 51, and a peripheral portion 107 having slightly inclined segments extending angularly and forming bearing surfaces 108. The minimum number of these bearing surfaces 108 is two. Finally, the lateral face of the adjustment piece 103 is provided with two notched portions 109.

The frame 50 is shown in greater detail in FIGS. 18 and 19. It is provided with an inner shoulder 110 having two slightly inclined segments, forming counter-bearing surfaces 111 intended to cooperate with the bearing surfaces 108. The inner shoulder 110 is also provided with four threaded holes 112 designed for fixing the adjustment piece 103. Pawl means are provided, comprising two spurs 113 mounted elastically on the inner wall of the frame 50 and cooperating with the notched portions 109 in order to ensure that the piece 103 is angularly positioned in an incremental manner.

The adjustment piece 103 is placed, inside the frame 50, on the shoulder 110, the bearing surfaces 108 coming into contact with the counter-bearing surfaces 111. Because of the inclination of said bearing surfaces, the angular position of the adjustment piece 103 determines its axial position inside the frame 50, and in particular the position of its flat central portion 106. The latter is designed to serve as an abutment for the cam 51, thereby making it possible for the translational travel of the cam follower 52 to be finely regulated and for the injection chamber 100 to be optimally clamped. During the manual clamping operation using the control knob 102, the cam 51, which is mounted in the frame 50 with a slight translational play, bears on the central portion 106 of the adjustment piece 103. Depending on the height position of the adjustment piece 103, the translation travel of the cam follower 52 is greater or lesser and the force for clamping the injection chamber 100 is higher or lower. The adjustment piece is therefore positioned angularly so as to optimize the clamping force and is then fixed axially by four screws fitted, through the oblong holes 104, into the threaded holes 112.

It does not matter whether the machine for preparing a drink according to the invention is provided with an injection assembly 6 actuated so as to close by deploying the head, or by the use of an independent means.

FIGS. 1 to 14 show one embodiment of a machine provided with an injection assembly 6 actuated so as to close by deploying the injection head. As a variant, the manual injection assembly 6 may be mounted on the head 21 through an opening, through which only the control knob 102 projects, so as to be actuated by the user.

A third embodiment of the machine according to the invention will now be described as illustrated in FIGS. 20 and 21. In this embodiment, the machine for preparing a drink comprises a casing 1 formed from a body 20 and a head 21, the head being mounted so as to move on the body 20. This embodiment differs from the embodiment described with regard to FIGS. 1 to 19 in that the head 21 is mounted so as to slide on the body 20 in the manner of a drawer. The injection assembly 6 is unchanged and its control functions on a similar principle (not illustrated), namely a lever mounted so as to be articulated, at a first end, on a fixed portion of the body and, at a second end, on a rotary cam. By deploying the head 21, as previously, the cam rotates over an angular portion that depends on the initial geometric parameters of the mechanism. By determining the relationship between the rotation angle θ of the cam and the translational displacement of the head 21 it is possible to optimize these parameters so as to have a high angle θₘₐₓ.

Of course, the machine for preparing a drink according to the invention is not limited to the embodiments that have been described, it being possible for various modifications and simple variants to be envisaged by a person skilled in the art without departing from the scope of the invention as defined by the appended claims.

In particular, it should be noted that, in the above description, the injection assembly 6 includes a capsule support 7, but a person skilled in the art might choose to replace this with a sachet support or with a support for an unpackaged consumable product, without departing from the scope of the invention. In this case, the injection assembly would be similar to that described above except that the cam follower 52 would not have a piercing needle 55 but a simple passage for the liquid. Moreover, the lower face 54 would bear directly on the shoulder 70 in order to lock the support 7 and seal the injection assembly 6.

1. Machine for preparing a drink, comprising a body and a head fitted with a liquid-injection assembly, which comprises a support to accommodate a portion of food ingredients and a passage through which the drink can flow, the head being mounted on the body such that it can move in order to move from a retracted stowage position, in which the space occupied by the machine is minimal and the passage is covered, into a deployed service position in which the space occupied by the machine is greater than the space occupied in the retracted position, in the retracted position, a housing is provided in the head to accommodate the support and, in the deployed position, the passage is uncovered in order to allow the drink to flow over an empty space intended for the insertion of a container.

2. Machine according to claim 1, wherein the support is removable and ready to be inserted into or removed from the head when the head is in the position in which it is retracted inside the housing.

3. Machine according to claim 1, wherein the head is pivotally mounted on the body.

4. Machine according to claim 3, wherein the head is pivotally mounted about an axis of rotation substantially longitudinal to the body.

5. Machine according to claim 1, wherein the head is slideably mounted on the body.

6. Machine according to claim 1, wherein the liquid-injection assembly comprises a locking member for the support.

7. Machine according to claim 6, wherein the locking member comprises a control designed to actuate automatically when the machine moves from the retracted position to the deployed position.

8. Machine according to claim 7, wherein the locking member comprises a cam mechanism actuated via the control.

9. Machine according to claim 8, wherein the locking member is formed from a frame, a cam able to rotate inside the frame, a cam follower able to move translationally inside the frame and a control, the cam and cam follower collaborating via inclined surfaces so that the cam follower is given a translational movement when the cam is rotated, and moves from a raised position in which the support is free, to a lowered position in which the support is locked.

10. Machine according to claim 7, wherein the control is formed of a lever mounted such that it is articulated by a first end to the cam and by a second end to a fixed part of the body so that the lever causes the cam to rotate when the head moves from the retracted position to the deployed position.

11. Machine according to claim 10, wherein the head is mounted on the body such that its translational movement is impeded by a fixed ring and the lever is mounted such that it is articulated by a second end to the ring.

12. Machine according to claim 9, wherein the surfaces comprise a steeply inclined first portion designed to bring the cam follower into contact with the support, and a less-steeply inclined second portion for clamping the support.

13. Machine according to claim 1, wherein the support is designed to accommodate a capsule.

14. Machine according to claim 1, wherein the injection assembly comprises a puncturing needle and an injection member for injecting the liquid into the needle.

15. Machine for preparing a drink, comprising a body and a head fitted with a liquid-injection assembly, which comprises a support to accommodate a portion of food ingredients and a passage through which the drink can flow, the head moveably mounted on the body so that it can move from a retracted stowage position into a deployed service position, in the retracted position, a housing is provided in the head to accommodate the support and, in the deployed position, the passage is uncovered and drink can flow over a space intended to be occupied by a container.
